(19) United States
(12) Patent Application Publication
(10) Pub. No.: US 2008/0073557 A1
(43) Pub. Date: Mar. 27, 2008

(54) Methods and apparatuses for directing an ion beam source

(76) Inventors: John German, Prairie Du Sac, WI (US); Klaus Hartig, Avoca, WI (US); John E. Madocks, Tucson, AZ (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/493,703

(22) Filed: Jul. 26, 2006

(51) Int. Cl. H01J 27/00

(52) U.S. Cl. 250/424

(57) ABSTRACT

A method and apparatus for directing an ion beam toward a surface of a substrate is disclosed. Certain embodiments of the invention relate generally to ion beam sources adapted to direct ion beams toward a surface of a substrate at an oblique angle of incidence relative to the surface. Certain embodiments of the invention are adapted to direct two ion beam portions toward a substrate surface, the ion beam portions having substantially equal throw distances. Preferred embodiments of the invention may be useful in etching applications, where the angle of incidence and throw distance of two ion beam portions are well suited for etching the surface of a substrate.

### FIELD OF THE INVENTION

The present invention relates generally to ion beam sources, and more particularly to closed-loop ion beam sources.

### BACKGROUND

An ion beam source is a device that causes gas molecules to be ionized, then focuses, accelerates and/or emits the ionized gas molecules and/or atoms in a beam toward a substrate. Such an ion beam may be used for various purposes including, but not limited to, cleaning a substrate, etching a substrate, milling off a portion of a substrate, and/or depositing film on a substrate.

An ion beam source may, for example, include cathode portions that define an ion-emitting slit. An anode may be arranged adjacent to the slit and the cathode so as to be spaced somewhat from the slit. An electric field may be generated between the anode and the cathode portions, for example, by the application of a voltage source. A magnetic field may be established such that the cathode portions and the ion-emitting slit are part of a magneto-conductive circuit. Electron collisions with a working gas in or proximate the electric field leads to ionization and a plasma is generated. The plasma expands and fills the ionization region around the ion emitting slit defined by the cathode portions. Electrons in an ion acceleration space proximate the slit are propelled by the vector cross product of electric and magnetic fields (i.e., the ExB field), and drift in a closed loop path within the region of crossed electric and magnetic field lines proximate the slit. An ion beam is thus directed from the slit toward a substrate.

Anode layer ion beam sources have been used in industrial applications. Typical anode layer ion beam sources have an elongated oval-shaped ion emitting slit (or racetrack gap) wherein the ions are generated and ejected towards a work piece at high energy. The process is similar to that carried out using a magnetron sputtering cathode, wherein electrons are trapped by crossed electrical and magnetic fields to increase the probability of ionizing collisions with a neutral gas species. Unlike sputtering cathodes, however, the ions of an anode layer source are accelerated away from the device to form ion beams.

A conventional anode layer ion beam source has a racetrack gap formed between an inner cathode pole and an outer cathode pole. A plane can be defined across this gap between facing pole surfaces. The ion beam emanates generally orthogonally to this plane. In prior art anode layer ion beam sources, the racetrack gap plane at all areas of the ion beam lies in a single plane; all areas of the resultant ion beam therefore emanate from points along the racetrack-shaped gap in substantially parallel paths.

If used for applications such as etching or etch cleaning, Applicant has discovered that the etching effectiveness of an ion beam can be influenced by a combination of factors. Two of these factors are the length of ion beam travel from the source to the workpiece (i.e., the “throw distance”), and the angle of incidence of the ion beam with respect to the workpiece. Applicant has discovered that etching effectiveness tends to be optimized by using a short throw distance, while also using an angle of incidence of about 60°-70°. However, when a conventional anode layer ion beam source is oriented at the preferred angle of incidence, the throw distance around the racetrack gap varies (e.g., one side of the racetrack gap has a greater throw distance than the other), reducing the etching effectiveness of the affected side. This may be due to scattering and divergence of the affected ion beam as a result of collisions with neutrals and other charged species along a longer path of ion travel.

### BRIEF SUMMARY OF THE INVENTION

In certain embodiments of the invention, an ion beam source has a closed-loop ion-emitting slit capable of directing a collimated ion beam toward a substrate surface at an angle oblique to the substrate surface. In certain preferred embodiments, the ion-emitting slit may have two long sections in which ion beam portions emitted therefrom have substantially equal throw distances.

In certain embodiments of the invention, a method is provided for directing an ion beam toward a substrate surface. The method includes providing a housing formed of cathode inner and outer portions spaced to form a closed-loop slit therebetween, the slit being configured such that an ion beam emitted from the slit is oriented at an oblique angle relative to a substrate.

In another exemplary embodiment, a method of processing a substrate includes depositing a first coating on a first major surface of the substrate, and etching a second major surface of the substrate to remove oversprayed coating material from depositing the first coating. The etching process may employ an ion beam source that directs two ion beam portions at an oblique angle to the second major surface, the ion beam portions having throw distances that are substantially the same.

In still another exemplary embodiment, a coater is provided having a series of vacuum deposition chambers with a plurality of transport rollers for transporting a substrate along a path of substrate travel. An ion beam source is located beneath the path of substrate travel, and is adapted to emit an ion beam upwardly in a divergent pattern. Preferably, the ion beam has two portions with substantially equally throw distances.

In yet another exemplary embodiment, there is provided a coater having a series of serially connected vacuum chambers. The coater in the present embodiments has a path of substrate travel along which can be conveyed a large-area substrate having a width of at least 1.5 meters, and the path of substrate travel is defined by a plurality of transport rollers. The coater has an ion beam source that is located beneath the path of substrate travel and is adapted to emit an ion beam upwardly toward the path of substrate travel. The ion beam source in the present embodiments preferably is mounted to a top lid of one of the vacuum deposition chambers. Preferably, the ion beam source can be removed from the chamber by lifting the top lid off the chamber thereby moving the ion beam source upwardly between two adjacent ones of the transport rollers.

In still another exemplary embodiment, there is provided a method of processing a substrate. The present method includes depositing a first coating over a first major surface of the substrate, wherein during the deposition of the first coating, an overspray of material is deposited on a second major surface of the substrate. The first and second major surfaces will commonly be generally opposed. In the present embodiment, the method includes etching the second major surface of the substrate to remove at least some of the overspray, and this etching preferably involves directing a collimated ion beam toward the second major surface. In the present method, the ion beam can optionally be emitted from an ion beam source having a slit with two long sections that are generally parallel to each other, such that two ion beam portions are emitted respectively from the two long sections of the slit so as to form a convergent pattern and have substantially equal throw distances.

In yet another exemplary embodiment, there is provided a method of processing a substrate. The present method includes depositing a first coating over a first major surface of the substrate, wherein during the deposition of the first coating, an overspray of material is deposited on a second major surface of the substrate. The first and second major surfaces commonly will be generally opposed surfaces. The present method includes etching the second major surface of the substrate to remove at least some of the overspray, and this etching comprises directing an ion beam toward the second major surface. In the present embodiment, the ion beam can optionally be emitted from an ion beam source having a slit with two long sections that are generally parallel to each other, wherein two ion beam portions emitted respectively from the two long sections of the slit are substantially parallel to each other and have substantially equal throw distances.

In still another exemplary embodiment, there is provided an ion beam source with a closed-loop ion-emitting slit capable of emitting an ion beam toward a substrate surface. In the present embodiment, the ion beam source comprises a housing that includes a cathode inner portion and a cathode outer portion. Preferably, the outer portion extends around the inner portion and is spaced from the inner portion to form the closed-loop slit therebetween. The housing has a longitudinal axis and a transverse axis, and these axes define an operating plane. In the present embodiment, the closed-loop slit forms a slit plane that is oblique to the operating plane. The ion beam source includes an anode disposed within the housing proximate the slit, as well as an electric power supply adapted to apply a voltage to the anode to form an electric field in an ionization region proximate the slit. Preferably, the ion beam source also includes a magnetic element adapted to generate magnetic lines of flux that pass through the slit, the cathode inner and outer portions, and the magnetic element to form a closed-loop magneto-conductive circuit. The ion beam source also preferably includes a gas supply adapted to deliver a working medium into the housing to form a collimated ion beam that is emitted from the slit when the working medium passes through the ionization region. In the present embodiments, the ion beam desirably has an ion beam direction that is substantially orthogonal to the slit plane such that the ion beam direction is oblique to the operating plane, the ion beam direction being defined by a centerline of the ion beam.

In yet another exemplary embodiment, there is provided a method of directing an ion beam toward a substrate surface. In the present embodiment, the method comprises providing a housing that includes a cathode inner portion and a cathode outer portion. Preferably, the outer portion extends around the inner portion and is spaced from the inner portion to form a closed-loop slit therebetween. In the present method, the housing desirably has a longitudinal axis and a transverse axis together defining an operating plane, and the closed-loop slit desirably forms a slit plane oriented at an oblique angle relative to the operating plane. The present method involves providing an anode within the housing proximate the slit, and supplying a positive voltage to the anode to form an electric field in an ionization region proximate the slit. The present method involves generating magnetic lines of flux that pass through the slit, and through the cathode inner and outer portions to form a closed-loop magneto-conductive circuit. A working medium is supplied into the housing to form a collimated ion beam that is emitted from the slit when the working medium passes through the ionization region. Preferably, the ion beam has an ion beam direction that is substantially orthogonal to the slit plane such that the ion beam direction is oriented at an oblique angle relative to the substrate surface, the ion beam direction being defined by a centerline of the ion beam.

### BRIEF DESCRIPTION OF THE DRAWINGS

The present invention will hereinafter be described in conjunction with the following drawing figures, wherein like numerals denote like elements:

FIG. 1 is a cross-sectional view of a prior art anode layer ion beam source;

FIG. 2 is a perspective view of an elongated housing configuration that can be used for an ion beam source in accordance with embodiments of the invention;

FIG. 3 is a cross-sectional view of an anode/cathode pole system that can be used for an ion beam source in accordance with embodiments of the invention;

FIG. 4 is an enlarged view of the area proximate an ion-emitting slit of the anode/cathode pole system shown in FIG. 3;

FIG. 5 is a side view of an ion beam source disposed at an oblique angle with respect to a surface of a substrate;

FIG. 6 is a side view of an ion beam source adapted to produce a collimated ion beam having an ion beam direction that is oblique to the surface of a substrate in accordance with certain embodiments of the invention;

FIGS. 7(a) and 7(b) are cross-sectional views of examples of ion beam sources according to some embodiments of the invention;

FIG. 8 is a cross-sectional diagram of an ion beam source with diverging ion beam portions according to an embodiment of the invention;

FIG. 9 is a cross-sectional diagram of an ion beam source with converging ion beam portions according to an embodiment of the invention;

FIG. 10 is a schematic diagram of a coater comprised of serially connected deposition chambers, one of which has an ion beam source below a path of substrate travel, in accordance with an embodiment of the invention;

FIG. 11 is a flow diagram describing a method of directing an ion beam at a substrate surface;

FIG. 12 is a schematic perspective view of an ion beam source mounted to a top lid of a vacuum deposition chamber according to an embodiment of the invention;

FIG. 13 is a schematic side view of a vacuum deposition chamber having a top lid to which an ion beam source is mounted according to an embodiment of the invention;

FIG. 14 is a side view of an ion beam source adapted to produce a collimated ion beam having an ion beam direction that is oblique to the surface of a substrate in accordance with certain embodiments of the invention; and

FIG. 15 is a schematic diagram of a coater comprised of serially connected deposition chambers, two of which include ion beam sources, in accordance with an embodiment of the invention.

### DETAILED DESCRIPTION

The following discussion is presented to enable a person skilled in the art to make and use the invention. Various modifications to the illustrated embodiments will be readily apparent to those skilled in the art given the present disclosure as a guide, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the invention. Skilled artisans will recognize that the examples provided herein have many useful alternatives that fall within the scope of the invention as claimed.

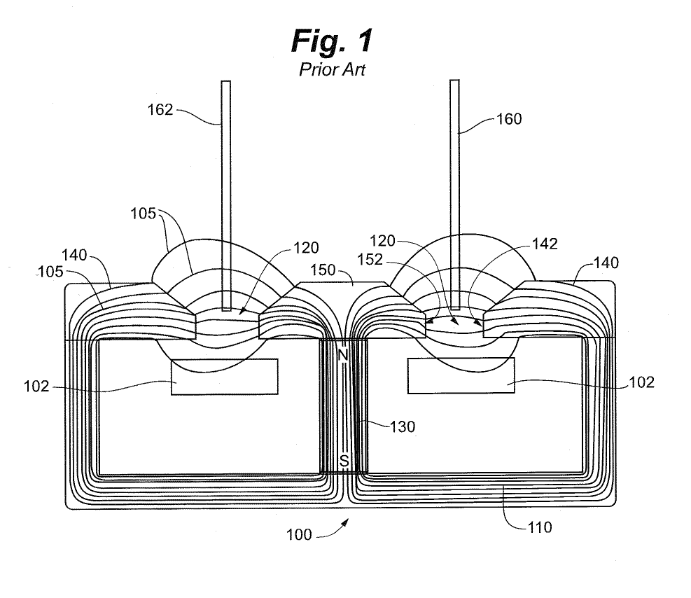

FIG. 1 is a cross-sectional view of a prior art anode layer ion beam source 100. Such a prior art source 100 may have an annular configuration, or may be elongated to form a relatively long (e.g., up to several meters or more) racetrack-shaped pattern. FIG. 1 shows a plurality of magnetic field lines 105 forming a magneto-conductive circuit through some of the components of anode layer ion beam source 100. The magnetic field lines 105 may be produced by a magnetic element, such as permanent magnet 130, and the magnetic field lines may be adapted to follow a magneto-conductive circuit through central pole piece 150, across gap or slit 120, through outer pole piece 140, and through magnetic shunt 110 to complete a path to permanent magnet 130, as shown in FIG. 1. An anode 102 may be disposed within a housing structure formed by the magnetic element, pole pieces, and shunt, for example, and may preferably be disposed proximate slit 120. Electrically, pole pieces 140, 150 and shunt 110 may be connected to ground, while anode 102 may be connected to the positive terminal of a relatively high voltage power supply to thereby establish an electric field. The electrical configuration of outer and inner pole pieces 140 and 150 with respect to anode 102 enable them to function as cathode portions (e.g., cathode outer portion 140 and cathode inner portion 150, respectively) of the ion beam source 100.

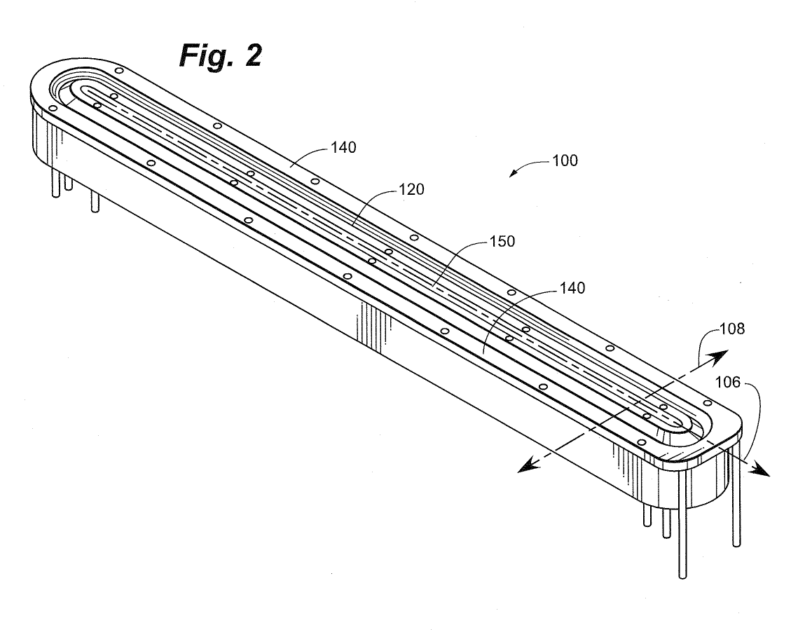

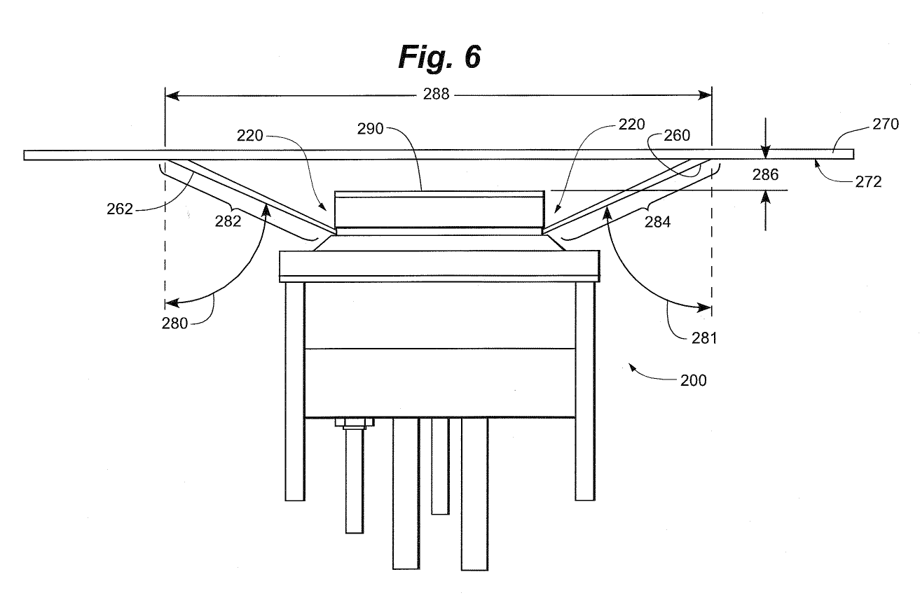

FIG. 2 is a perspective view of an elongated housing configuration that can be used for an ion beam source 100 according to certain embodiments of the invention. This housing configuration exemplifies a basic arrangement for inner and outer pole pieces 150, 140 to form a housing having a closed-loop slit 120 in a gap formed between the inner and outer pole pieces 150, 140. FIG. 2 also shows a longitudinal axis 106 and a transverse axis 108 of the elongated ion beam source 100 of FIG. 2. Longitudinal axis 106 and transverse axis 108 together define an operating plane of ion beam source 100. An elongated housing configuration of this basic design can be used advantageous for an ion beam source of the invention. Thus, the exemplary embodiments of FIGS. 6, 7A, 7B, 8, 9, or 14 can be embodied in the form of an elongated housing configuration of the general type shown in FIG. 2. Thus, in some embodiments of the invention, the ion beam source has a closed-loop slit with two long sections that are at least generally parallel to each other, and which can be generally parallel to a longitudinal axis of the ion beam source.

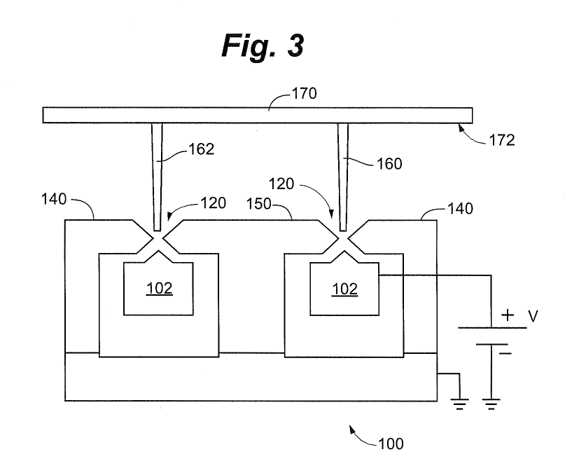

FIG. 3 is a cross-sectional view of an anode/cathode pole system that can be used for an ion beam source of the invention. FIG. 3 shows an arrangement for anode 102, pole pieces 140 and 150, and slit 120 to form ion beam portions 160 and 162 directed at a surface 172 of substrate 170. Anode 102 may be disposed within a housing formed at least in part by inner and outer pole pieces 140 and 150. Anode 102 may be disposed proximate the slit 120 (e.g., a certain distance from the slit), and near the poles 140 and 150. Preferably, the spacing of the anode 102 from the slit exceeds the Larmor radius of the captured electrons. As those skilled in the art will appreciate, the width of the slit 120 can be varied to maintain a magnetic field across the slit 120 of sufficient strength to ionize electrons and thereby allow a plasma to be formed proximate the slit. An electric power supply (e.g., voltage source, V) is shown in FIG. 3. Typically, the power supply is adapted to provide a positive voltage at anode 102 with respect to the pole pieces 140, 150, and to thereby generate an electric field in a region (e.g., an ionization region) proximate the slit. The pole pieces 140, 150 may be electrically connected to ground, as shown.

Ion beam portions 160, 162 are shown in FIG. 3 as being emitted from the slit 120 in a direction away from anode 102 and generally orthogonal to an operating plane of the ion beam source 100, as described above. In FIG. 3, the ion beam portions 160, 162 strike the substrate at a normal (i.e., 90%) angle. This figure, however, is simply provided to show an anode/cathode pole system that can be used for an ion beam source of the present invention. Thus, in embodiments of the invention like those shown in FIGS. 6, 7A, 7B, 8, 9, and 14, the ion beam portions are oblique to the substrate. Each ion beam source shown in FIGS. 6, 7A, 7B, 8, and 9 can be adapted to have an ion beam emitted from an elongated, closed-loop slit such that the ion beam includes two long (or “leg”) portions and two end (or “turnaround”) portions.

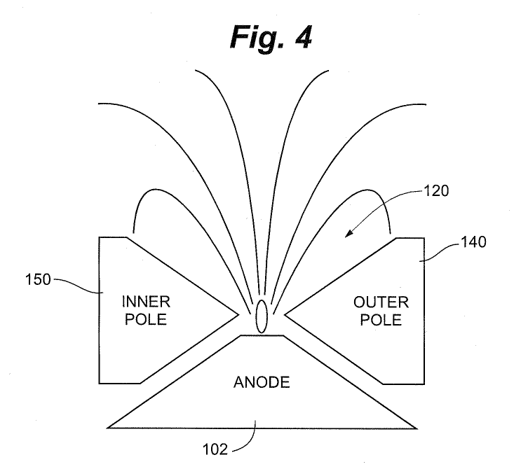

FIG. 4 is an enlarged view of an ionization region proximate the slit 120 of the anode/cathode pole system shown in FIG. 3. This shows an exemplary single center magnet configuration that can be used for the pole pieces 140 and 150, and the anode 102 near the slit 120. A pointed pole system of the illustrated nature can be used for embodiments of the present invention to create a magnetic mirror confinement region in the area of the slit 120. This can act to collimate the resulting ion beam as it is formed and directed away from the slit and toward the surface of a substrate. A collimated ion beam is desirable for etching, etch-cleaning, etc.

Magnetic mirror confinement is discussed in US Published Patent Application 2005/0247885 to Madocks. The “magnetic mirror ratio” refers to the ratio of the field strength at an end of a magnetic field line (e.g., where the field is relatively strong) to the minimum field strength along that field line. In certain embodiments of the invention, a magnetic mirror field is formed in the slit and has a minimum magnetic mirror ratio of greater than about 2. As noted above, a magnetic mirror confinement can be incorporated advantageously into an ion beam source of the present invention. Therefore, the teachings of U.S. 2005/0247885 are incorporated herein by reference.

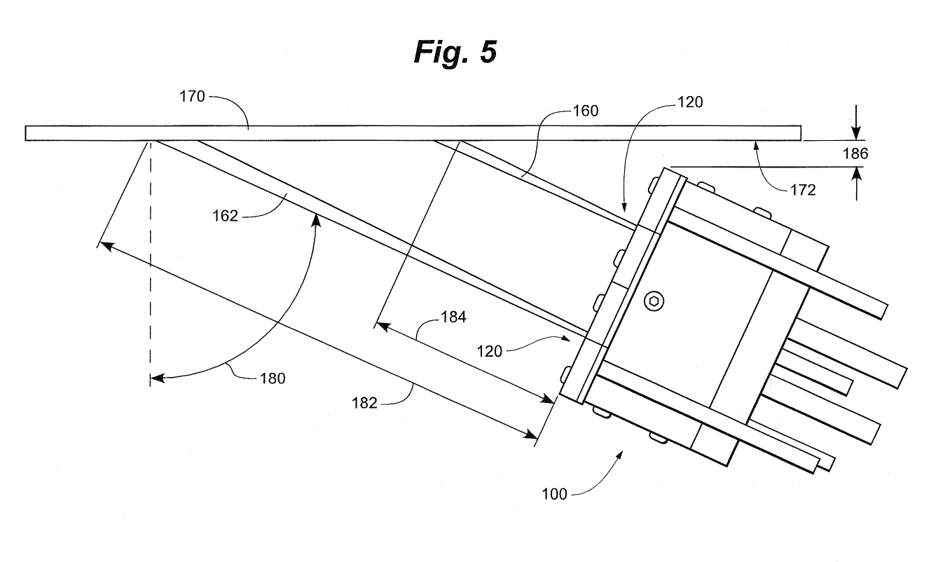

FIG. 5 illustrates an ion beam source 100 that has been disposed (e.g., tilted) such that the operating plane of the ion beam source 100 is at an oblique angle with respect to a surface 172 of a substrate 170. As used herein, the term “oblique angle” refers to an angle that is neither parallel nor perpendicular. In FIG. 5, ion beam portions 160 and 162 are directed toward the surface 172 of substrate 170 at an oblique angle of incidence 180, for example, to enhance the etching effectiveness of the ion beam. Here, though, the two long portions of the ion beam have different throw distances, as described below.

As used herein, the “angle of incidence” is the angle formed between the centerline CL of an incident ion beam as it impinges a surface and an axis orthogonal to that surface. The particular angle chosen for angle of incidence 180 can be any angle of incidence that is suitable to achieve the desired etching effectiveness, for example, anywhere from about 10 to 80 degrees, and preferably between about 45 and 75 degrees, and more preferably between about 60 and 70 degrees. In particularly preferred embodiments, an angle of incidence 180 of about 65 degrees is chosen. The angle chosen may be affected or limited by space considerations, such as the clearance 186 that may be desired between the housing of the ion beam source and the substrate, or any transport mechanism used in transporting the substrate 170 relative to the ion beam source 100 (e.g., transport rollers or the like). The transport mechanism would normally only come into play for those embodiments involving an ion beam source located beneath a path of substrate travel.

FIG. 5 illustrates that by attempting to optimize etching effectiveness simply by using a preferred angle of incidence, the ion beam portions 160, 162 emitted from the two long portions of the slit 120 travel different distances (“throw distances”) prior to reaching the surface 172 of the substrate 170. The longer throw distance of one ion beam portion can result in reduced etching effectiveness for that ion beam portion. For example, in FIG. 5, ion beam portion 162 has a throw distance 182 that is substantially longer than the throw distance 184 of ion beam portion 160. Thus, ion beam portion 162 will not achieve the same etching effectiveness as ion beam portion 160 due to the longer throw distance, with other factors being equal.

In order to optimize the angle of incidence while minimizing the throw distance along the racetrack path of the ion beam (e.g., to improve etching effectiveness), an ion beam source in accordance with embodiments of the invention has an anode, cathode poles, and ion-emitting slit arranged in novel configurations. Certain embodiments of the invention include an ion-emitting closed-loop slit with a slit plane that allows different portions of the ion beam to impinge the substrate at a desired oblique angle of incidence, while maintaining a substantially uniform throw distance to the substrate.

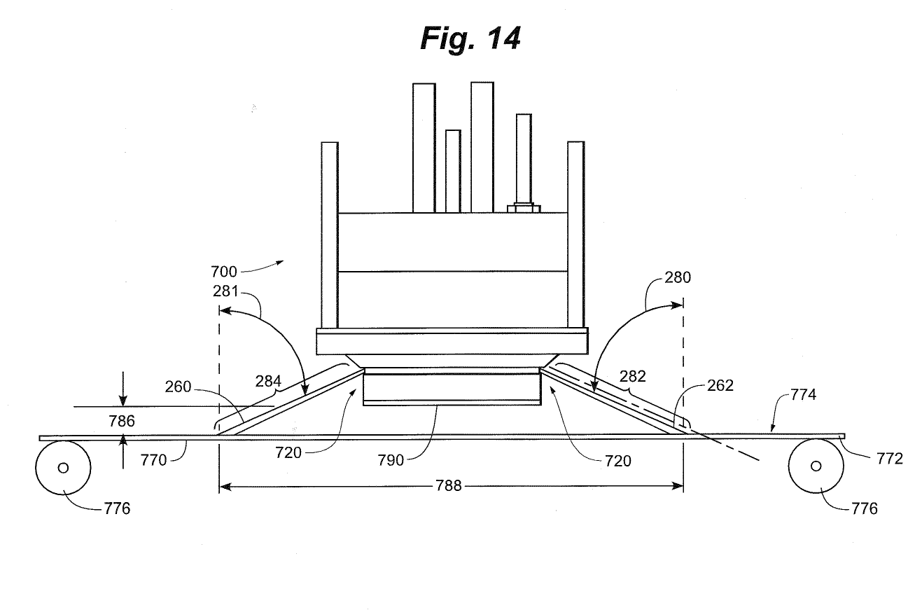

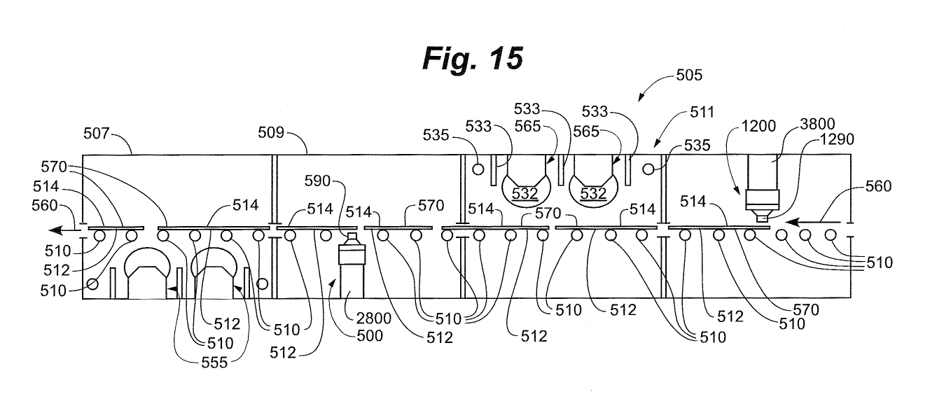

In some embodiments, an ion beam source is located above a path of substrate travel and is adapted to emit an ion beam generally downwardly toward the path of substrate travel. One example is shown in FIG. 14. In other embodiments, an ion beam source is located beneath a path of substrate travel and is adapted to emit an ion beam generally upwardly toward the path of substrate travel. One example is shown in FIG. 6. Further, some embodiments provide a coater that includes at least one upper source (such as source 1200 in FIG. 15) and at least one lower source (such as source 500 in FIG. 15). In FIG. 15, the lower source 500 is further along the path of substrate travel than the upper source 1200. This, however, may not be the case in other embodiments where both upper and lower sources are in a single coater.

According to an embodiment of the invention, an ion beam source 200 produces ion beam portions 260, 262 that diverge when moving away from the ion beam source (i.e., with increasing distance from the source) to form a divergent pattern such that the beam portions impinge the surface 272 of a substrate 270 at certain angles of incidence 280, 281 and with substantially the same throw distance 282, 284, as generally depicted in FIG. 6. Ion beam portions 260 and 262 are emitted from two relatively long sections of slit 220. Preferably, these sections of the slit are at least generally (or substantially) parallel to each other (e.g., similar to slit 120 shown in FIG. 2). As shown in FIG. 6, an ion beam source 200 in accordance with certain embodiments may produce a focused or collimated ion beam having an ion beam direction that is oblique to the operating plane of the ion beam source (and oblique to the substrate surface being treated). For example, in FIG. 6, ion beam source 200 is disposed such that its operating plane (and a front surface 290 of the ion beam source) is substantially parallel to the surface 272 of the substrate 270. However, the ion beam portions 260 and 262 are directed such that they diverge when moving away from the ion beam source 200 to form a divergent pattern as they move toward substrate 270, forming oblique angles of incidence 280, 281 with respect to the substrate surface 272. Preferably, the angles 280, 281 are equal, substantially equal, or generally equal. FIG. 14 shows an exemplary embodiment wherein an ion beam source with corresponding features and configuration is mounted above the path of substrate travel.

A clearance 286 between the ion beam source 200 and the substrate 270 may be chosen according to requirements for space, for example, to allow clearance of transport rollers, or the like, that may be used to move the substrate relative to the ion beam source. The amount of clearance 286 provided, in combination with the desired angles of incidence 280, 281, may interact so that the ion beam portions 260 and 262 impinge the surface 272 of substrate 270 with a transverse displacement between them, hereinafter referred to as the beam spread 288 (see FIG. 6). The clearance 286 may be the distance between a front face 290 of the ion beam source 200 and a surface 272 of the substrate 270. In some embodiments, the front face 290 is substantially parallel to the surface 272 of the substrate 270. In certain embodiments, the amount of clearance 286 is chosen by mounting the ion beam source such that the front face 290 is within the ion beam's mean-free-path distance from the surface 272. In some embodiments, the ion beam source is mounted such that the front face 290 is less than about two inches, or less than about one inch (such as about ½ inch), from the surface 272.

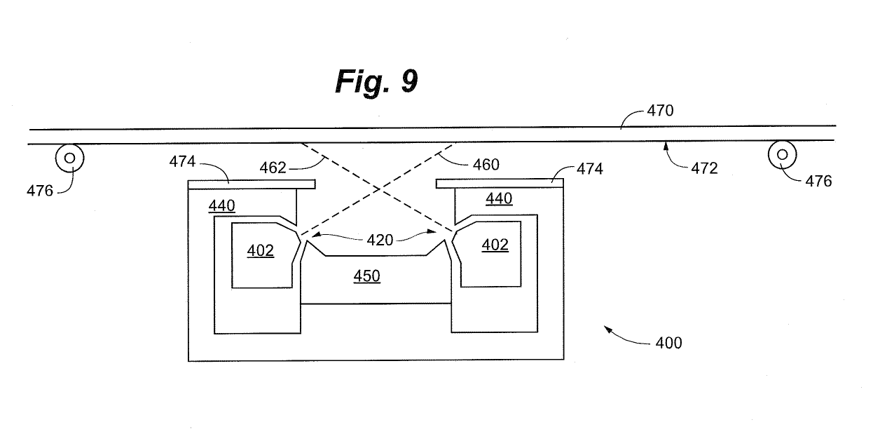

In certain embodiments of the invention, the effectiveness of the ion beam source 200 (e.g., for etching and cleaning applications) is improved by optimizing the throw distance 282, 284 of the ion beam portions 260 and 262, while maintaining a desired angle of incidence 280, 281 for both ion beam portions 260 and 262. In the embodiment shown in FIG. 6, for example, the angles of incidence 280, 281 are substantially equal to each other, and the throw distances 282, 284 are also substantially equal to each other. It is to be understood that modifications may be possible or desirable to accommodate different applications. For example, some anticipated embodiments involve using angles of incidence 280 and 281 that are slightly different from each other, throw distances 282 and 284 that are slightly different from each other, or both. The invention also provides alternate embodiments wherein two ion beam portions are directed to form a convergent pattern as they move from the ion source toward the surface of the substrate. One embodiment includes two ion beam portions that converge at a single point on the substrate. Another embodiment is shown in FIG. 9. In still another embodiment, two long portions of the beam remain substantially parallel to each other, have substantially the same angle of incidence, and also have substantially the same throw distance, as described below.

Other geometries may be possible for dealing with non-planar work pieces. For example, the racetrack gap could be formed into a circular or cylindrical shape, whereby the beam could be directed radially outward or inward, for example, to treat the inside or outside of a cylindrical substrate.

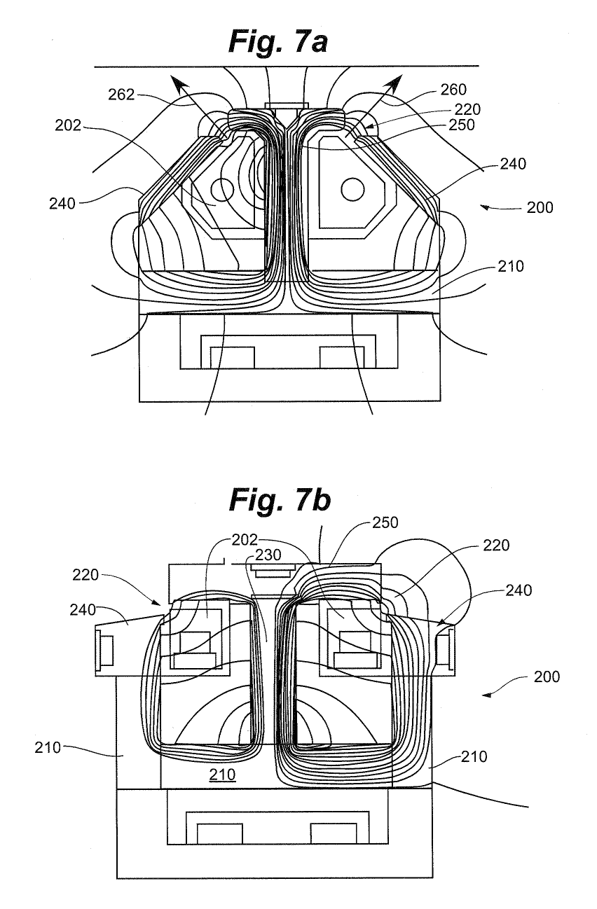

FIGS. 7(a) and 7(b) are cross-sectional views of ion beam sources according to certain embodiments of the invention. For example, FIG. 7(a) shows an ion beam source having a closed-loop ion-emitting slit 220 adapted for emitting an ion beam toward the surface of a substrate (e.g., the surface of a sheet of glass). The ion beam source of FIG. 7(a) has a housing that includes a cathode inner portion 250, and a cathode outer portion 240. The cathode outer portion 240 extends around the cathode inner portion 250, and is spaced from the inner portion 250 to form the slit 220 between the inner and outer portions 240, 250. For example, in an embodiment of the invention in which an elongated housing configuration is employed, the cathode outer portion 240 can extend around the periphery of the cathode inner portion 250 such that two generally long portions of the cathode outer portion 240 are disposed on opposite sides of a longitudinal axis of the ion beam source. The housing can include a magnetic shunt 210 to form a magneto-conductive circuit that flows in a path from the cathode inner portion 250, across the slit 220, through the cathode outer portion 240, and continuing through the magnetic shunt 210 to return to the cathode inner portion 250. In some embodiments, a magnetic element 230 adapted to generate magnetic lines of flux (e.g., a permanent magnet) may be coupled to or integrated with the cathode inner portion 250 and/or with the shunt 210 to generate the magnetic fields that form the magneto-conductive circuit.

The cathode inner and outer portions 240 and 250 can be made of any suitable magneto-conductive material, including metals and alloys such as iron, iron alloys (e.g., steel, magnetic stainless steel), nickel, superalloy, mu-metal, and alnico, for example without limitation. In some embodiments, the cathode inner and outer portions 240 and 250 are arranged to form a closed-loop ion-emitting slit 220 having substantially uniform dimensions (e.g., width, depth) throughout the closed-loop path formed by the slit 220.

A slit plane can be formed with respect to the closed-loop slit 220 at any given point along (preferably entirely along) its path. In some embodiments, the slit plane is formed along a substantially direct path across the slit 220 (e.g., along the shortest path from cathode inner portion 250 to cathode outer portion 240). In some embodiments, the slit plane is surrounded by magnetic field lines crossing the slit 220. As shown in FIGS. 7(a) and 7(b), a slit plane may form an oblique angle with the operating plane of the ion beam source, as well as with the surface of a substrate, according to embodiments of the invention. As also shown in the embodiments of FIGS. 7(a) and 7(b), the slit plane along one long portion of the ion beam source can form an angle that is of the same (or substantially the same) magnitude, but is oriented in an opposite direction, as the angle formed by the slit plane along the other long portion of the ion beam source. In various embodiments of the invention, the ion beam emitted from the slit 220 is emitted in a direction generally orthogonal to the slit plane.

In the embodiment shown in FIG. 7(a), the cathode outer portion 240 is generally aligned with (e.g., generally parallel to) the slit plane. In some embodiments, at least a portion of (optionally all of) the cathode outer portion lies in a plane that is substantially parallel to the slit plane, as shown in FIG. 7(a). The embodiment of FIG. 7(a) is characterized by the housing (or at least a portion thereof) having a generally triangular cross-sectional configuration (e.g., for a cross section taken along a plane orthogonal to the longitudinal axis of the ion beam source).

In the embodiment of FIG. 7(b), a generally “square-shaped” housing is used for the ion beam source 200. The slit 220 in the embodiment of FIG. 7(b) nonetheless defines a slit plane that forms an oblique angle with the operating plane of the ion beam source. For example, the upper inner edge of the cathode outer portion 240 is disposed relative to an outer lower edge of the cathode inner portion 250 to form a slit plane at an oblique angle.

In the embodiments of FIGS. 7(a) and (b), a gas supply 280 is adapted to deliver a working medium into the housing. Gas supply 280 can be provided via a penetration into (e.g., a gas line extending into) the housing whereby the gas can move into the space between the cathode portions 240, 250 and the anode, and around the anode to the slit. In some embodiments, a manifold is disposed within the housing as part of the gas supply 280. A gas-delivery manifold can be disposed proximate the anode, for example, to provide a more uniform delivery/distribution of the working medium from gas supply 280, to provide faster response time, or both. These features, however, are not required in all embodiments of the invention. When the working medium passes through the ionization region in the area proximate the slit, an ion beam is formed and emitted from the slit in a direction generally orthogonal to the slit plane (and hence, at an oblique angle to the operating plane of the ion beam source 200). In some embodiments of the invention, the working medium includes a gas selected from the group consisting of oxygen, nitrogen, argon, hydrocarbons, and mixtures of such gases. The working medium can additionally or alternatively include a gas selected from the group consisting of CF₄, halogens, and halides.

In certain embodiments, the ion beam is a collimated or focused ion beam, where the ion beam direction is defined by a centerline of the beam. Preferably, the ion beam is collimated. In certain embodiments, the ion beam is collimated and does not widen or narrow substantially prior to impinging the substrate (e.g., maintains a substantially constant spread along its throw distance). A collimated ion beam can be formed, for example, using a pointed pole configuration, such as that described above with respect to FIG. 4, and as described in U.S. Published Patent Application 2005/0247885.

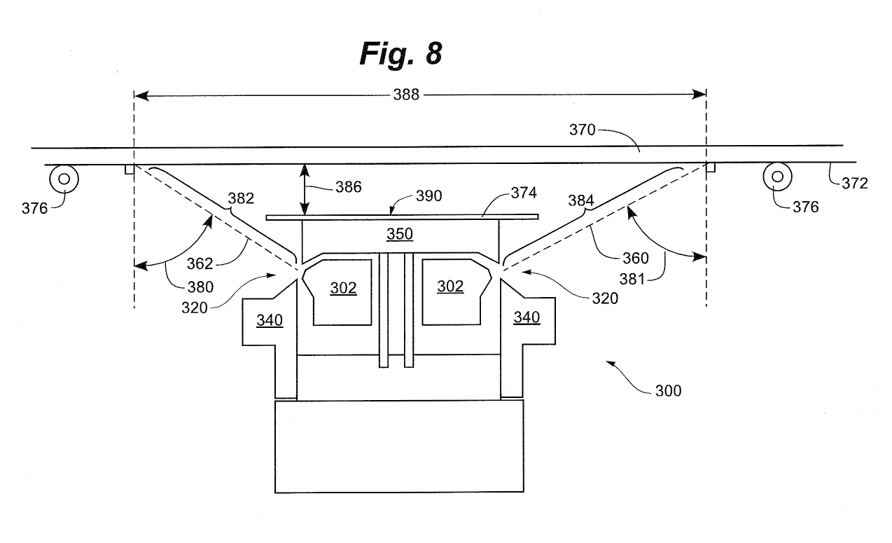

FIG. 8 shows an ion beam source 300 adapted to emit ion beam portions that form a divergent pattern as they move away from the source 300. Here, the ion beam source 300 includes a housing comprising a cathode inner portion 350 and a cathode outer portion 340. The cathode outer portion 340 extends around the cathode inner portion 350, and is spaced from the inner portion 350 to form a slit 320 between the inner and outer portions 340, 350. Preferably, the poles are provided with conventional water cooling. An anode 302 is disposed within the housing.

An optional debris shield 374 is shown in FIG. 8. Here, the shield is disposed above the cathode inner portion 350 in accordance with certain embodiments of the invention. Thus, a debris shield can optionally be provided on the ion beam source. Such a shield may be particularly advantageous in embodiments where the ion beam source is located below the substrate being treated. In FIG. 8, a surface of the debris shield 374 forms the front face 390 of the ion beam source 300 and is spaced from the surface 372 of a substrate 370 by a desired clearance 386. These features, however, are not required in all embodiments involving a debris shield. The debris shield 374 extends outwardly from the cathode inner portion 350 to at least partially cover, or shield, slit 320 from debris that might otherwise fall vertically downward into the slit 320.

Debris shield 374, when provided, can be formed in a variety of shapes and sizes. The shield can be designed to keep foreign objects from passing into the slit 320, for example, by extending the shield outwardly from the cathode inner portion 350, as shown in FIG. 8, thereby obstructing a direct vertical path between the substrate surface 372 and the slit 320. Debris shield 374 can comprise (e.g., consist essentially of), for example, of a low work function material capable of tolerating high temperatures. Debris shield 374 may be further adapted to emit electrons, according to certain embodiments of the invention. In certain embodiments of the invention, the debris shield 374 may be comprised of (or may consist essentially of) materials such as tungsten, thorium, iridium, thoriated iridium, or other materials having similar properties, as well as various combinations of these and other similar materials, for example without limitation. The debris shield 374 may include a surface coating comprising (e.g., formed of) the above-mentioned materials (e.g., a thorium coated surface).

Transport rollers 376 are also shown in FIG. 8. Transport rollers 376 or other substrate supports can be used to move a substrate 370 relative to (e.g., so as to pass underneath or above) the ion beam source 300, for example, to allow the ion beam emitted from the slit 320 to impinge the surface 372 of the substrate 370.

As shown in FIG. 8, ion beam portions 360, 362 may be emitted from the slit 320 of the ion beam source 300 to form a divergent pattern as the ion beam portions 360, 362 travel toward the surface 372 of the substrate 370. Ion beam portions 360, 362 are directed toward the substrate surface 372 such that they form oblique angles of incidence 381, 380, respectively, with the surface 372. Surface 372 of the substrate 370 may be substantially planar, and may be arranged such that surface 372 is maintained substantially parallel to the operating plane of the ion beam source 300, for example, during any travel of the substrate 370 relative to the ion beam source 300 (e.g., during conveyance of the substrate on transport rollers 376). For example, when the substrate is a glass sheet being conveyed (e.g., by transport rollers) past the ion beam source, the substrate preferably is conveyed in a configuration (optionally a horizontal configuration) in which the surface 372 being treated is maintained substantially parallel to the operating plane of the ion beam source.

In certain embodiments of the invention, angles of incidence 381, 380 include angles ranging from about 10 degrees to about 80 degrees, where the angle of incidence is measured between a centerline of the ion beam and an axis orthogonal to the surface 372. In some embodiments, the angle of incidence is between about 30 and 70 degrees, and may more preferably be between about 55 and 70 degrees. In a particularly preferred embodiment, the angle of incidence is between about 63 and 67 degrees.

In certain embodiments of the invention, the ion beam source 300 is disposed relative to the substrate 370 such that the throw distances 382, 384 of the ion beam portions 362, 360, respectively, are each less than about 3 inches. In some embodiments of the invention, the throw distances may each be between about 0.5 and 2.5 inches, and in one preferred embodiment, a throw distance of about 1 inch (or less) is used.

In certain embodiments, the beam spread 388 formed by ion beam portions 360 and 362 extends a certain distance in a transverse direction (e.g., along a transverse axis of the ion beam source). In some embodiments, the beam spread 388 is a distance that is less than the distance between two adjacent transport rollers 376 of a conveying system, substantially as shown in FIG. 8. The beam spread 388 can optionally be less than about 20 inches, and may more preferably be less than about 10 inches. The beam length formed by ion beam portions 360 and 362 may extend in the longitudinal direction (e.g., along a longitudinal axis of the ion beam source). The beam length in some embodiments is greater than about 12 inches, and may be greater than about 75 inches according to certain preferred embodiments.

FIG. 9 shows an ion beam source 400 adapted to provide ion beam portions that form a convergent pattern when initially emitted from the source 400 toward the surface of a substrate. Ion beam source 400 includes a housing comprising a cathode inner portion 450 and a cathode outer portion 440. The cathode outer portion 440 extends around the cathode inner portion 450, and is spaced from the inner portion 450 to form the slit 420 between the inner and outer portions 440, 450. An anode 402 is disposed within the housing.

In FIG. 9, a debris shield 474 is disposed above the cathode outer portion 440 in accordance with certain embodiments of the invention. A surface of the debris shield 474 can optionally form a front face of the ion beam source 400. In FIG. 9, the front face of the ion beam source is spaced from the surface 472 of the substrate 470. Debris shield 474 extends inwardly from the cathode outer portion 440 to at least partially cover, or shield, the slit 420 from debris that might otherwise fall into the slit 420. Debris shield 474 may be formed in a variety of shapes and sizes. The shield can be designed to keep foreign objects from passing into the slit 420, for example, by extending the shield inwardly from the cathode outer portion 440, as shown in FIG. 9, thereby obstructing a direct vertical path between the surface 472 and the slit 420. Debris shield 474 can comprise (e.g., consist essentially of) a low work function material capable of tolerating high temperatures. Debris shield 474 may be further adapted to emit electrons, according to certain embodiments of the invention. In certain embodiments of the invention, the debris shield 374 may be comprised of (or may consist essentially of) materials such as tungsten, thorium, iridium, thoriated iridium, or other materials having similar properties, as well as various combinations of these and other similar materials, for example without limitation. The debris shield 374 may include a surface coating comprising (e.g., consisting essentially of) the above-mentioned materials (e.g., a thorium coated surface). Transport rollers 476 are also shown in FIG. 9. Rollers 476 can be used to move the substrate 470 relative to the ion beam source 400, for example, to allow the ion beam emitted from the slit 420 to impinge the surface 472 of the substrate 470.

As shown in FIG. 9, ion beam portions 460, 462 may be emitted from slit 420 of ion beam source 400 to form a convergent pattern as the ion beam portions 460, 462 initially travel toward a surface 472 of a substrate 470. Ion beam portions 460, 462 are directed toward the substrate surface 472 such that they form oblique angles of incidence with the surface 472. The substrate surface 472 can be substantially planar, and may typically be arranged such that the surface 472 is maintained substantially parallel to the operating plane of the ion beam source 400, for example, as the substrate 470 travels relative to the ion beam source 400 (e.g., while moved via transport rollers 476).

In some embodiments, the ion beam portions 460, 462 may be adapted to impinge the surface 472 of the substrate 470 along two lines (e.g., with a measurable beam spread therebetween), or may be adapted to impinge the surface substantially along a single line. In FIG. 9, the converging ion beam pattern or arrangement is achieved by disposing the cathode outer portion 440 generally closer to the substrate 470 than is the cathode inner portion 450 (e.g., the cathode outer portion 440 can optionally be disposed above the cathode inner portion 450 for some such embodiments where the source is below the substrate). In the embodiment shown in FIG. 9, the ion beam portions cross paths as they travel toward the surface 472 of the substrate 470. In other embodiments, it may be preferable to have a convergent ion beam pattern where the ion beams do not cross paths prior to striking the substrate, or where the ion beams impinge the surface 472 along a single line.

In certain embodiments of the invention, angles of incidence 481, 480 include angles ranging from about 10 degrees to about 80 degrees. In some embodiments, the angle of incidence may be between about 30 and 70 degrees, and may more preferably be between about 55 and 70 degrees. In a particularly preferred embodiment, an angle of incidence of between about 63 and 67 degrees (e.g., about 65 degrees) is used. In some cases, a majority (i.e., 50% or more, desirably 65% or more, or even substantially all) of the ions of the ion beam strike the substrate at an impingement angle within one or more of the angle ranges noted in this disclosure.

In certain embodiments, the ion beam source 400 may be disposed relative to the substrate 470 such that the throw distances of the ion beam portions 462, 460 are each less than about 3 inches. In some embodiments of the invention, the throw distances are each between about 0.5 and 2.5 inches, and in one preferred embodiment, a throw distance of about 1 inch (or less) is used.

In some embodiments, the beam spread 488 formed by ion beam portions 460 and 462 extends a certain distance in the transverse direction. For example, the beam spread 488 can optionally extend a distance that is less than the distance between two adjacent transport rollers 476 of a conveying system, substantially as shown in FIG. 9. This may advantageously minimize any etching of the rollers. In certain embodiments, the beam spread 488 is less than about 20 inches, and may more preferably be less than about 10 inches. A beam length formed by ion beam portions 460 and 462 may extend in a longitudinal direction (e.g., along a longitudinal axis of the ion beam source). The beam length in some embodiments is greater than about 12 inches, and may be greater than about 75 inches according to certain preferred embodiments.

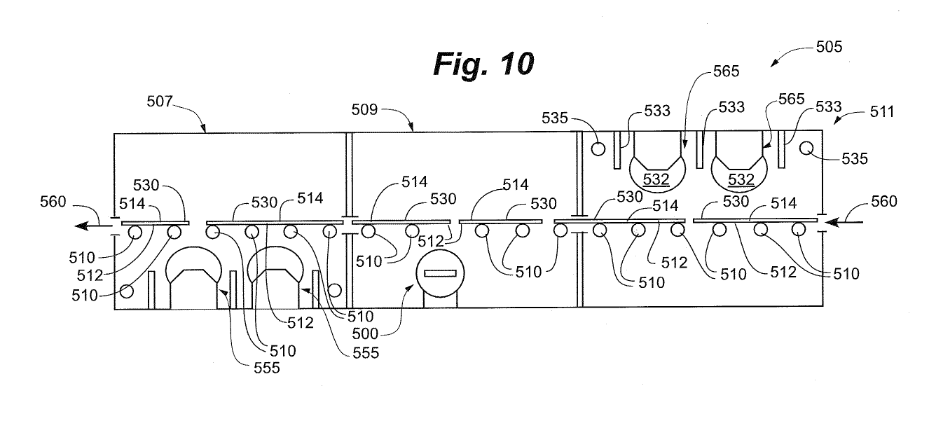

FIG. 10 is a schematic diagram of a coater 505 having serially connected vacuum deposition chambers 507, 509, 511 in accordance with an exemplary embodiment of the invention. Downward coating apparatuses 565 are disposed in chamber 511. These apparatuses 565 are adapted for coating a top major surface 514 of a substrate 570 conveyed along the path of substrate travel 560. In coater 505, the path of substrate travel 560 extends through the vacuum deposition chambers 507, 509, 511 and is defined by a plurality of transport rollers 510, although other substrate supports can be used. In embodiments of this nature (or any other embodiments of the invention), the ion beam source may be adapted for use (and may be operated) in a vacuum deposition chamber in which there is maintained a controlled environment having a pressure of between about 1 mtorr. and about 30 mtorr, such as about 2-3 mtorr.

When provided, the downward coating apparatuses 565 can be any type of downward coating apparatuses. In certain preferred embodiments, each downward coating apparatus 565 is a downward sputtering apparatus. In such embodiments, the downward sputtering apparatuses comprise sputtering targets 532 positioned above (i.e., at a higher elevation than) the path of substrate travel 560. The coater 505 can also be provided with gas distribution pipes 535 (e.g., having outlets) positioned above the path of substrate travel 560. It may also be preferred to provide upper anodes 533 above the path of substrate travel 560.

In other embodiments, one or more of the downward coating apparatuses 565 may be chemical vapor deposition apparatuses. A CVD apparatus of this nature will typically comprise a gas supply from which the precursor gas is delivered through the gas outlet and into the upper region of the coater. If so desired, such a downward coating apparatus can be a plasma-enhanced chemical vapor deposition apparatus of the type described in U.S. patent application Ser. No. 10/373,703, entitled “Plasma-Enhanced Film Deposition” (Hartig), filed on Dec. 18, 2002, the salient portions of which are hereby incorporated by reference.

In certain embodiments, at least one of the downward coating apparatuses 565 comprises an ion gun. Such an ion gun can be part of a downward ion-assisted deposition process. For example, it can be part of an ion beam sputter deposition source comprising a sputtering target 532 against which the ion gun accelerates ions, such that atoms of the target material are ejected from the target downwardly toward the substrate. This type of ion-assisted deposition method is known in the art, as are other suitable ion-assisted deposition methods.

It has been discovered that the bottom surface of a substrate can become inadvertently coated due to overspray from a downward coating operation, such as that which could be carried out in chamber 511 of FIG. 10. For example, when material is sputtered downwardly onto the top surface of a substrate, some of the sputtered material can actually find its way onto the bottom surface of the substrate. This phenomenon has been found to leave unwanted coating on marginal portions of the substrate's bottom surface. Further, if a coating is subsequently applied to the bottom surface by an upward coating operation, portions of this bottom surface (e.g., near the edges) may end up carrying both the desired coating and the unwanted oversprayed coating, while the central portion of this surface carries only the desired coating. This non-uniformity could potentially have a variety of adverse effects on the intended coating properties and/or the desired specifications. Other undesirable traces of contact may also be left upon the bottom surface of a substrate. These include marks from transport rollers, suction cups, etc.

In certain embodiments, one or more ion beam sources are provided in a coater to address the problems noted above. In some cases, at least one ion beam source is mounted beneath the path of substrate travel 560. In the embodiment shown in FIG. 10, the ion beam source 500 is located further along the path of substrate travel 560 than at least one downward coating apparatus 565. In FIG. 10, an ion beam source 500 is adapted to emit an ion beam from a slit in the source 500 such that the beam is directed upwardly between two adjacent ones of the transport rollers 510 toward the path of substrate travel. Ion beam source 500 may be configured such that the slit has two long sections that are at least generally parallel to each other. The ion beam emitted from the slit may thus have two long portions that emanate from the two long sections of the slit. The ion beam source 500 can be configured such that the two long portions of the ion beam have substantially equal throw distances. In some cases, these two beam portions form a divergent pattern as they move toward (e.g., with decreasing distance from) the path of substrate travel 560, although these beam portions can alternatively have convergent or parallel configurations as described herein. This enables the ion beam source 500 to remove, for example, oversprayed coating material (and/or other contaminants, possibly traces of contact) from the bottom major surface 512 of the substrate 570. In some embodiments, the ion beam source 500 is mounted on a top lid (or another removable top wall) of one of the vacuum deposition chambers 507, 509, 511 so that the ion beam source 500 can be removed from the chamber by lifting the lid off the chamber.

If upward coating apparatuses 555 are also provided, they can optionally be located further along the path of substrate travel 560 than the (or at least one) ion beam source 500. This enables the ion beam source 500 to remove (preferably all, or substantially all) undesirable material from the bottom surface 512 of the substrate 530 before this surface 512 is coated during a subsequent operation of the upward coating apparatuses 555.

FIG. 15 depicts an exemplary embodiment wherein prior to the first downward coating apparatus on a coater's path of substrate travel, there is mounted (e.g., by brackets 3800 or the like) an upper ion beam source 1200. The ion beam source 1200 can, for example, be mounted in the first processing chamber of the coater.

A method of processing a substrate, according to certain embodiments of the invention, involves the use of a coater such as that described above with respect to FIG. 10. One exemplary method includes depositing a first coating (optionally using a downward coating process) over a first major surface of a substrate, and subsequently etching (optionally using an upward etching process) a second major surface of the substrate to remove at least some overspray that resulted from depositing the first coating. Etching the second major surface may comprise directing a collimated ion beam toward the second major surface of the substrate. The collimated ion beam can advantageously be emitted from an ion beam source having a slit with two long sections that are generally parallel to each other. Two ion beam portions can be emitted from two such long sections of the slit. The ion beam portions preferably have substantially equal throw distances. In certain embodiments, the two ion beam portions form a divergent pattern as the ion beam portions travel toward the second major surface of the substrate. The ion beam source may be substantially as described above according to certain embodiments of the invention.

In certain embodiments of the invention, the ion beam comprises two long portions forming a convergent pattern as the ion beam portions travel toward the second major surface. These ion beam portions preferably have substantially equal throw distances. In an alternate embodiment of the invention, the two ion beam long portions may be emitted such so as to be substantially parallel to each other as they travel toward the second major surface. Preferably, the two long portions have the same angle of incidence, but are emitted from locations offset in the direction of substrate travel, with the offset being selected to give both beam portions the same throw distance. For example in FIG. 5, the housing could be configured such that the slit section from which beam portion 162 emanates is forward of the slit section from which beam portion 160 emanates. Thus, the long portions of the beam can have the same throw distance, even if there is variation of the throw distance at the turnaround portions of the beam.

In FIG. 10, the first major surface of the substrate is a top (e.g., upwardly facing) surface, and the second major surface is a bottom (e.g., downwardly facing) surface of a substrate. The same is true for FIG. 15. Preferably, the path of substrate travel extends substantially horizontally through the coater. The substrate may be conveyed through the coater at a speed of, for example, about 100-500 inches per minute.

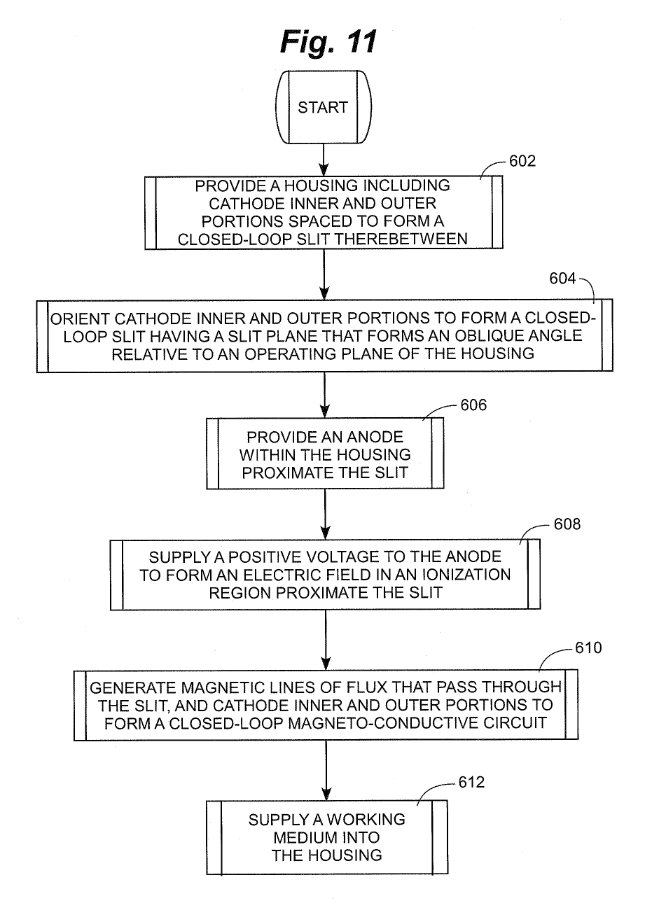

FIG. 11 is a flow diagram describing an exemplary method of directing an ion beam at a substrate surface in accordance with embodiments of the invention. The exemplary method of FIG. 11 includes providing a housing including a cathode inner portion and a cathode outer portion, as shown at step 602. The outer portion may extend around the inner portion and be spaced from the inner portion to form a closed-loop slit therebetween. In step 604, the closed-loop slit forms a slit plane that is oriented at an oblique angle relative to the operating plane of the housing, for example, by orienting the cathode inner and outer portions in a manner similar to that described above with respect to FIGS. 8 and 9. In step 606, an anode is provided within the housing proximate the slit. Step 608 involves supplying a positive voltage to the anode to form an electric field in an ionization region proximate the slit. Magnetic lines of flux are generated, as shown at step 610. The lines of flux pass through the cathode inner and outer portions, as well as through the slit, to form a closed-loop magneto-conductive circuit. At step 612, a working medium is supplied into the housing, so that an ion beam is formed and emitted from the closed-loop slit in a direction substantially orthogonal to the slit plane such that the ion beam direction is oriented at an oblique angle relative to the surface of the substrate. The working medium supplied into the housing may be oxygen or any other gas(es) described above. The ion beam direction can be determined based on a centerline of the ion beam.

In certain embodiments of the invention, the closed-loop ion-emitting slit formed according to the above-described method may include two long sections from which two ion beam portions are emitted. The ion beam portions emitted from the two long sections of the slit may have substantially equal throw distances according to certain embodiments. In certain embodiments, the ion beam portions emitted from the two long sections of the slit form a divergent pattern as they move (at least initially) toward the surface of the substrate. In an alternative embodiment, the ion beam portions emitted from the two long sections of the slit form a convergent pattern as they move toward the surface of the substrate. In another alternative embodiment, the ion beam portions emitted from the two long sections of the slit are substantially parallel to each other.

In the above-described method, the angle of the slit plane relative to the operating plane can advantageously be controlled (according to certain embodiments of the invention) such that the ion beam direction forms an angle of incidence with the substrate of between 10 and 80 degrees, wherein the substrate is substantially planar and substantially parallel to the operating plane. In some embodiments, the ion beam direction forms an angle of incidence with the substrate of between 60 and 70 degrees, such as between 63 and 67 degrees (e.g., about 65 degrees).

In certain embodiments of the invention, the ion beam source is operated such that a beam spread (e.g., the transverse distance between the locations where the ion beam portions impinge the surface of the substrate) is created, and the beam spread is less than a distance between two adjacent transport rollers of a conveying system.

In certain embodiments of the invention, the voltage applied to the anode is a positive voltage greater than about 1000 volts. In some applications, it may be desirable to use higher voltage levels, such as voltages greater than about 2000 volts, greater than about 3000 volts, or greater than about 5000 volts (such as about 7000-8000), or even greater than about 12,000 volts.

The above-described method may be employed to remove certain films or contaminants (e.g., traces of contact) from a substrate according to certain embodiments of the invention. For example, the method may direct an ion beam to impinge a major surface of a substrate to remove dielectric film from the major surface, and/or to remove contaminants from the major surface. As used herein, “contaminants” may include substances such as hydrocarbons, oils, transfer marks (e.g., from suction cups, transport rollers or conveyor belts), and glass stains, for example without limitation. The rate at which certain films and/or contaminants may be removed from the surface of a substrate can be quantified in terms of an “etch rate”. The etch rate can be used to quantify the depth and speed with which films and contaminants can be removed from a substrate surface. It should be noted that, to be useful as a comparison tool, the etch rate of a given process may typically be given with respect to a particular standard, for example, an etch rate of X angstrom-inches per minute of clear soda lime glass. In certain embodiments of the invention, the etch rate is at least about 4300 angstrom-inches per minute. It also should be noted that the etch rates observed on certain films and contaminants may be different than that determined with respect to the standard. For example, the etch rate for removing zinc oxide from a surface of a substrate may be roughly 30% greater than that determined for clear soda lime glass.

In certain embodiments of the invention, the etch rate is at least about 5000 angstrom-inches per minute. In some embodiments, the etch rate is at least about 7000 angstrom-inches per minute, at least about 15,000, or at least about 20,000 angstrom-inches per minute (perhaps about 25,000 angstrom-inches per minute or more). The etch rates reported herein are for etching clear soda lime glass. The ion beam source embodiments described above are advantageous in that they can provide exceptionally high etch rates. Embodiments involving a collimated ion beam with two long portions at optimized angle of incidence and substantially identical throw distances can provide particular advantage in terms of high etch rate. Advantageous embodiments of this nature allow the ion beam source to be used in very close proximity to the substrate. Further, certain methods involve using the ion beam source at particularly high power levels, as described above. Thus, by providing one or more of these features, highly advantageous etch rates can be achieved.

In certain embodiments of the invention, a plasma is formed from the working medium supplied into the housing. The plasma may be centered within the slit according to certain embodiments by establishing a magnetic mirror confinement region in the area proximate the slit. This may be accomplished, for example, by using a pointed pole arrangement similar to that described above in U.S. Published Patent Application 2005/0247885 (Madocks).

The working medium supplied into the housing may further comprise a substance (e.g., a dopant) for minimizing pole erosion. For example, a dopant in the working medium may cause material to be deposited on the poles during operation. In some embodiments, the material is deposited on the poles at substantially the same rate at which the ion beam source removes material. In some embodiments, the dopant may comprise a hydrocarbon gas, such as methane.

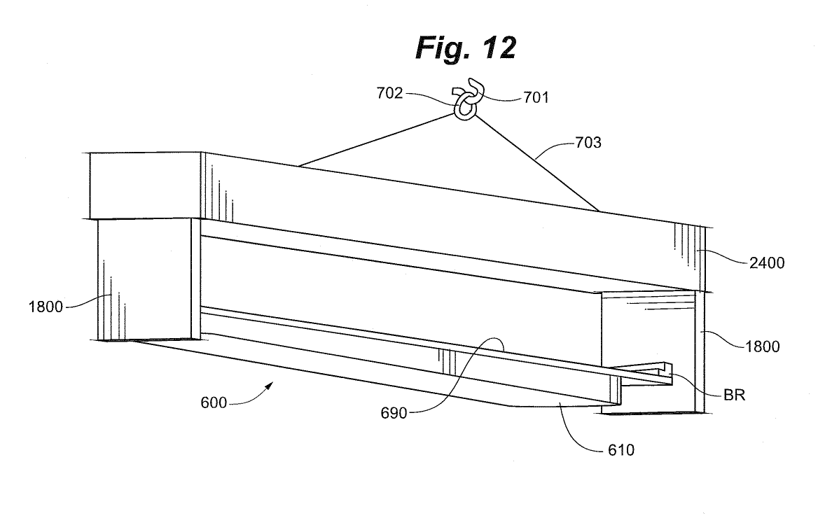

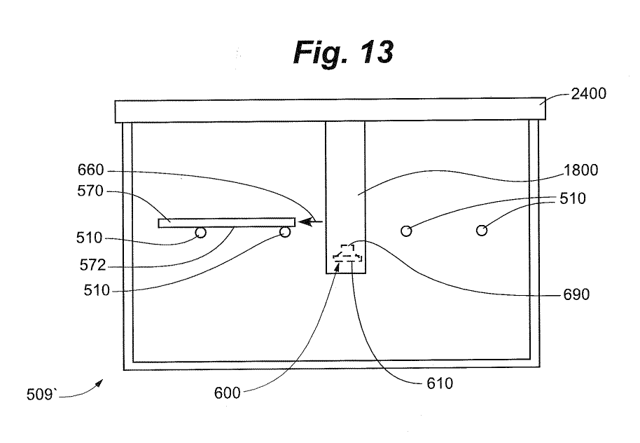

FIGS. 12 and 13 depict certain embodiments of the invention wherein an ion beam source 600 is mounted to a top lid 2400 of a vacuum deposition chamber 509, 509′. When the top lid 2400 is operatively positioned on the chamber, as shown in FIG. 13, the ion beam source 600 is located beneath a path of substrate travel 660 and is adapted to emit an ion beam upwardly toward the path of substrate travel. The ion beam source is mounted to the top lid and can be removed from its operative position within the chamber by lifting the top lid off the vacuum deposition chamber thereby moving the ion beam source upwardly between two adjacent transport rollers 510. Thus, the ion beam source is sized so as to be moveable between two adjacent transport rollers 510 in the chamber. In certain preferred embodiments, the transport rollers are adapted to convey a large-area substrate (e.g., a glass sheet) having a width of at least 1.5 meters, a length of at least 1.5 meters, or both. Thus, the rollers may be at least 1.5 meters long. In FIG. 12, it can be appreciated that the top lid and ion beam source can be removed from the chamber as an integral unit by lifting the top lid away from the chamber. An overhead lift (e.g., a crane or the like with a hook 701) can be secured to a link 702 on a cable 703 anchored at its end to the top lid. This type of lift-off removal is an advantageous method by which the top lid and ion beam source can be lifted from the chamber quickly and easily, for example, to facilitate convenient maintenance of the ion beam source. Embodiments of the nature described in this paragraph can involve any ion beam source described in this disclosure. The ion beam source in these embodiments, however, can be of other designs as well. For example, an anode layer ion beam source like those described above with reference to FIGS. 1 and 3 can be used. Useful ion sources can be obtained commercially from General Plasma, Inc. (Tucson, Ariz., USA). Other suitable ion sources can be obtained from Veeco (Ft. Collins, Colo., USA), such as those sold under the trade names ALS 106C, ALS 144L, ALS 340L, ALS 340W. Reference is made to U.S. Pat. No. 6,147,354 (Maishev et al.), the salient contents of which are incorporated herein by reference, in which there is described operation of an anode-layer type ion source in a vacuum chamber. The ion beam source, whatever its particular type, is mounted to the top lid (e.g., by brackets and anode bellows), and preferably is sized to fit through a space between two adjacent transport rollers in a vacuum deposition chamber on which the top lid fits.

A variety of substrates are suitable for use in the present invention. In most cases, the substrate is a sheet of transparent material (i.e., a transparent sheet). However, the substrate is not required to be transparent. For example, opaque substrates may be useful in some cases. However, it is anticipated that for most applications, the substrate will comprise a transparent or translucent material, such as glass or clear plastic. In many cases, the substrate will be a glass sheet. A variety of known glass types can be used, and clear soda-lime glass is expected to be preferred.

Substrates of various size can be used in the present invention. Certain embodiments involve a substrate having a width and/or length of at least about 0.5 meter, preferably at least about 1 meter, perhaps more preferably at least about 1.5 meters (e.g., between about 2 meters and about 4 meters), and in some cases at least about 3 meters. The ion beam source desirably is adapted for emitting an ion beam that spans substantially the entire width (preferably the entire width) of the substrate. For example, the ion gun preferably emits a curtain-like ion beam that spans the entire width of the surface being treated.

Substrates of various thickness can be used in the present invention. Commonly, substrates with a thickness of about 1-5 mm are used. Some embodiments involve a substrate with a thickness of between about 2.3 mm and about 4.8 mm, and perhaps more preferably between about 2.5 mm and about 4.8 mm. In some cases, a sheet of glass (e.g., clear soda-lime glass) with a thickness of about 3 mm is used. One group of embodiments involves a glass sheet having a thickness of about 6 mm or more.

Thus, METHODS AND APPARATUSES FOR DIRECTING AN ION BEAM SOURCE are provided. While exemplary embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An ion beam source with a closed-loop ion-emitting slit capable of emitting an ion beam toward a substrate surface, the ion beam source comprising:
a housing including a cathode inner portion and a cathode outer portion, the outer portion extending around the inner portion and being spaced from the inner portion to form the closed-loop slit therebetween, the housing having a longitudinal axis and a transverse axis, said axes defining an operating plane, the closed-loop slit forming a slit plane that is oblique to the operating plane;
an anode disposed within the housing proximate the slit;
an electric power supply adapted to apply a voltage to the anode to form an electric field in an ionization region proximate the slit;
a magnetic element adapted to generate magnetic lines of flux that pass through the slit, the cathode inner and outer portions, and the magnetic element to form a closed-loop magneto-conductive circuit; and
a gas supply adapted to deliver a working medium into the housing to form a collimated ion beam that is emitted from the slit when the working medium passes through the ionization region, the ion beam having an ion beam direction that is substantially orthogonal to the slit plane such that the ion beam direction is oblique to the operating plane, the ion beam direction being defined by a centerline of the ion beam.

2. The ion beam source of claim 1 wherein the ion beam source has a front face that is at least generally parallel to the substrate surface.

3. The ion beam source of claim 2 wherein the ion beam source is mounted such that its front face is within a mean-free-path distance of the ion beam from the substrate surface.

4. The ion beam source of claim 2 wherein the ion beam source is mounted such that its front face is less than one inch from the substrate surface.

5. The ion beam source of claim 1 wherein the magnetic element is adapted to form a magnetic mirror field in the slit, the magnetic mirror field having a minimum magnetic mirror ratio of greater than about 2.

6. The ion beam source of claim 1 wherein the ion-emitting slit has two long sections that are at least generally parallel to each other, and wherein ion beam portions emitted from the two long sections of the slit have substantially equal throw distances.

7. The ion beam source of claim 6 wherein the ion beam portions emitted from the two long sections of the slit form a divergent pattern as they move toward the substrate surface.

8. The ion beam source of claim 6 wherein the ion beam portions emitted from the two long sections of the slit form a convergent pattern as they move toward the substrate surface.

9. The ion beam source of claim 6 wherein the ion beam portions emitted from the two long sections of the slit are substantially parallel to each other as they move toward the substrate surface.

10. The ion beam source of claim 6 wherein said throw distance is less than about 3 inches.

11. The ion beam source of claim 6 wherein said throw distance is between about 0.5 and about 2.5 inches.

12. The ion beam source of claim 6 wherein said throw distance is about 1 inch or less.

13. The ion beam source of claim 1 wherein the ion beam direction forms an angle of incidence of between about 10 and about 80 degrees.

14. The ion beam source of claim 1 wherein the ion beam direction forms an angle of incidence of between about 30 and about 70 degrees.

15. The ion beam source of claim 1 wherein the ion beam direction forms an angle of incidence of between about 55 and about 70 degrees.

16. The ion beam source of claim 1 wherein the ion beam direction forms an angle of incidence of between about 63 and about 67 degrees.

17. The ion beam source of claim 1 wherein the ion beam source is provided, in combination, with a conveying system defining a path of substrate travel, the ion beam source being disposed at a lower elevation than the path of substrate travel.

18. The ion beam source of claim 17 wherein the ion beam source is disposed at a lower elevation than the path of substrate travel and yet is mounted to a top lid of a vacuum deposition chamber through which the path of substrate travel extends, the path of substrate travel being defined by a plurality of transport rollers, and wherein the top lid and the ion beam source are adapted to be removed as an integral unit by lifting the top lid off the vacuum deposition chamber thereby moving the ion beam source upwardly between two adjacent ones of the transport rollers.

19. The ion beam source of claim 17 wherein the source is adapted to create a beam spread along the transverse axis, the beam spread being less than a distance between two adjacent transport rollers of the conveying system, such that the ion beam can be emitted upwardly between such two adjacent transport rollers.

20. The ion beam source of claim 1 wherein the ion beam source is adapted to create a beam spread along the transverse axis, the beam spread being less than about 20 inches.

21. The ion beam source of claim 1 wherein the ion beam source is adapted to create a beam spread along the transverse axis, the beam spread being less than about 10 inches.

22. The ion beam source of claim 1 wherein the ion beam source is adapted to create a beam length along the longitudinal axis, the beam length being greater than about 12 inches.

23. The ion beam source of claim 1 wherein the ion beam source is adapted to create a beam length along the longitudinal axis, the beam length being greater than about 75 inches.

24. The ion beam source of claim 1 further comprising a debris shield adapted to keep foreign objects from falling vertically downwardly into the slit.

25. The ion beam source of claim 24 wherein the debris shield comprises a low work function material capable of tolerating high temperatures and adapted to emit electrons.

26. The ion beam source of claim 24 wherein the debris shield comprises tungsten.

27. The ion beam source of claim 24 wherein the debris shield comprises thorium.

28. The ion beam source of claim 24 wherein the debris shield comprises thoriated iridium.

29. The ion beam source of claim 24 wherein the debris shield is positioned directly above, and at least partially covers, the slit.

30. The ion beam source of claim 29 wherein the debris shield extends from the cathode inner portion to at least partially cover the slit.

31. The ion beam source of claim 1 wherein the working medium comprises gas selected from the group consisting of oxygen, nitrogen, and argon.

32. The ion beam source of claim 1 wherein the working medium comprises CF₄.

33. The ion beam source of claim 1 wherein the working medium comprises an inert gas.

34. The ion beam source of claim 1 wherein the working medium comprises a halogen.

35. The ion beam source of claim 1 wherein the working medium comprises a halide.

36. A method of directing an ion beam toward a substrate surface, the method comprising:
providing a housing including a cathode inner portion and a cathode outer portion, the outer portion extending around the inner portion and being spaced from the inner portion to form a closed-loop slit therebetween, the housing having a longitudinal axis and a transverse axis together defining an operating plane, the closed-loop slit forming a slit plane that is oriented at an oblique angle relative to the operating plane;
providing an anode within the housing proximate the slit;
supplying a positive voltage to the anode to form an electric field in an ionization region proximate the slit;
generating magnetic lines of flux that pass through the slit, and through the cathode inner and outer portions to form a closed-loop magneto-conductive circuit; and
supplying a working medium into the housing to form a collimated ion beam that is emitted from the slit when the working medium passes through the ionization region, the ion beam having an ion beam direction that is substantially orthogonal to the slit plane such that the ion beam direction is oriented at an oblique angle relative to the substrate surface, the ion beam direction being defined by a centerline of the ion beam.

37. The method of claim 36 wherein the slit has two long sections from which two ion beam portions are emitted respectively, said two ion beam portions having substantially equal throw distances.

38. The method of claim 37 wherein the two long sections of the slit are at least generally parallel to each other.

39. The method of claim 37 wherein the two ion beam portions emitted respectively from the two long sections of the slit form a divergent pattern as they move toward the substrate surface.

40. The method of claim 36 comprising orienting the angle of the slit plane relative to the operating plane such that the ion beam direction forms an angle of incidence of between about 10 and about 80 degrees.

41. The method of claim 36 comprising controlling the angle of the slit plane relative to the operating plane such that the ion beam direction forms an angle of incidence of between about 60 and about 70 degrees.

42. The method of claim 36 wherein the ion beam impinges the substrate surface and is adapted to provide a removal rate of at least about 4300 angstrom-inches per minute for clear soda-lime glass.

43. The method of claim 36 wherein the ion beam impinges the substrate surface and is adapted to provide a removal rate of at least about 5000 angstrom-inches per minute for clear soda-lime glass.

44. The method of claim 36 wherein the ion beam impinges the substrate surface and is adapted to provide a removal rate of at least about 7000 angstrom-inches per minute for clear soda-lime glass.

45. The method of claim 36 wherein the ion beam impinges the substrate surface and is adapted to provide a removal rate of at least about 20,000 angstrom-inches per minute for clear soda-lime glass.

46. The method of claim 36 wherein the ion beam impinges the substrate surface, removing a dielectric film from the substrate surface.

47. The method of claim 36 comprising operating the ion beam source to create a beam spread along the transverse axis, the beam spread being less than a distance between two adjacent transport rollers of a conveying system such that the ion beam is emitted upwardly between the two adjacent transport rollers to impinge the substrate surface.

48. The method of claim 36 wherein the positive voltage is greater than about 1000 volts.

49. The method of claim 36 wherein the positive voltage is greater than about 3000 volts.

50. The method of claim 36 wherein the positive voltage is greater than about 5000 volts.

51. The method of claim 36 wherein the positive voltage is greater than about 12,000 volts.

52. The method of claim 36 wherein a plasma is formed from the working medium, the plasma being centered within the slit by establishing a magnetic mirror confinement region.

53. The method of claim 36 wherein the working medium is oxygen.

54. The method of claim 36 wherein the working medium comprises a dopant for minimizing pole erosion.

55. The method of claim 54 wherein the dopant causes material to be deposited on poles of the ion beam source at substantially the same rate at which the ion beam source removes material from the poles.

56. The method of claim 54 wherein the dopant comprises a hydrocarbon gas.

57. The method of claim 54 wherein the dopant comprises methane.

58. The ion beam source of claim 36 wherein the ion beam emitted from the ion beam source includes two beam portions that form a convergent pattern as they move toward the substrate surface.

59. The ion beam source of claim 36 wherein the ion beam emitted from the ion beam source includes two beam portions that are substantially parallel to each other.

60. A method of processing a substrate, the method comprising:
depositing a first coating over a first major surface of the substrate, wherein during the deposition of the first coating, an overspray of material is deposited on a second major surface of the substrate, the first and second major surfaces being generally opposed;
etching the second major surface of the substrate to remove at least some of the overspray;
wherein said etching comprises directing a collimated ion beam toward the second major surface, the ion beam being emitted from an ion beam source having a slit with two long sections that are at least generally parallel to each other, wherein two ion beam portions emitted respectively from the two long sections of the slit form a divergent pattern and have substantially equal throw distances.

61. The method of claim 60 wherein said etching includes:
providing a housing including a cathode inner portion and a cathode outer portion, the outer portion extending around the inner portion and being spaced from the inner portion to form the slit therebetween, the housing having a longitudinal axis and a transverse axis together defining an operating plane, the slit forming a slit plane that is oriented at an oblique angle relative to the operating plane;
providing an anode within the housing proximate the slit;
supplying a positive voltage to the anode to form an electric field in an ionization region proximate the slit;
generating magnetic lines of flux which pass through the anode, slit, and cathode inner and outer portions to form a closed-loop magneto-conductive circuit; and
supplying a working medium into the housing to form said ion beam, wherein said ion beam is emitted from the slit when the working medium passes through the ionization region, said ion beam having an ion beam direction that is substantially orthogonal to the slit plane such that the ion beam direction is oriented at an oblique angle relative to the second major surface of the substrate, the ion beam direction being defined by a centerline of the ion beam.

62. A coater having a series of serially connected vacuum deposition chambers, wherein the coater has a path of substrate travel defined by a plurality of transport rollers, the coater having an ion beam source located beneath the path of substrate travel, the ion beam source having a slit with two long sections that are at least generally parallel to each other, the ion beam source being adapted to emit an ion beam having two portions that emanate respectively from the two long sections of the slit, wherein the ion beam source is configured such that said two portions of the ion beam have substantially equal throw distances and form a divergent pattern when moving toward the path of substrate travel, the ion beam source being adapted to emit the ion beam upwardly between two adjacent ones of the transport rollers.

63. The coater of claim 62 wherein the ion beam source is mounted to a top lid of a desired one of the vacuum deposition chambers such that the ion beam source can be removed from said desired vacuum deposition chamber by lifting the top lid off said desired vacuum deposition chamber.

64. A coater having a series of serially connected vacuum deposition chambers, the coater having a path of substrate travel adapted for conveying a large-area substrate having a width of at least 1.5 meters, the path of substrate travel being defined by a plurality of transport rollers, the coater having an ion beam source that is located beneath the path of substrate travel and yet is mounted to a top lid of a desired one of the vacuum deposition chambers, wherein the ion beam source and the top lid can be removed from said desired vacuum deposition chamber as an integral unit by lifting the top lid off said desired vacuum deposition chamber thereby passing the ion beam source upwardly between two adjacent ones of the transport rollers.
